(19) United States
(12) Patent Application Publication
(10) Pub. No.: US 2025/0094616 A1
(43) Pub. Date: Mar. 20, 2025

(54) METHOD FOR PROTECTING PRIVACY DATA OF VEHICLE, AND VEHICLE

(71) Applicant: AutoX, Inc., Grand Cayman (KY)

(72) Inventor: Jianxiong Xiao, Shenzhen (CN)

(73) Assignee: AutoX, Inc., Grand Cayman (KY)

(21) Appl. No.: 18/890,809

(22) Filed: Sep. 20, 2024

(30) Foreign Application Priority Data
Sep. 20, 2023 (CN) 2023112196002

(51) Int. Cl. G06F 21/62; G06F 21/31

(52) U.S. Cl. CPC G06F 21/6218; G06F 21/31

(57) ABSTRACT

There is provided with a method for protecting privacy data of a vehicle, including step of: obtaining current sensing data of the vehicle; determining whether a current location of the vehicle is within a predetermined privacy protection locating range; when the current location of the vehicle is not within the predetermined privacy protection locating range, determining the current sensing data to be non-private data and uploading the current sensing data to one or more remote devices of the vehicle; when the current location of the vehicle is within the predetermined privacy protection locating range, determining the current sensing data to be private data and only saving the current sensing data to a local device of the vehicle.

This non-provisional patent application claims priority under 35 U.S.C. § 119 from Chinese Patent Application No. 2023112196002 filed on Sep. 20, 2023, the entire content of which is incorporated herein by reference.

### TECHNICAL FIELD

The disclosure relates to automotive data confidentiality technologies, in particular to a method for protecting privacy data of a vehicle, and a vehicle.

### BACKGROUND

In today's digital era, with the rapid development of big data and artificial intelligence, people's lives have become increasingly intelligence and convenient, yet they are also confront heightened risks of personal privacy information leakage. Specifically, amount of automotive data is growing exponentially, and capabilities of automotive data processors to collect the automotive data are also gradually enhancing. However, excessive collection of private data by the automotive data processors, including tracks of a vehicle, audio, video, images, and biometric features, and so on. In particular, the protection of private information is more important in private locations such as homes, companies, and hotels. Therefore, it is imperative to strengthen the protection of the privacy data of the vehicle in private locations.

### SUMMARY

There are provided with a method for protecting privacy data of a vehicle and a vehicle to effectively protect private data of the vehicle in private locations.

In a first aspect, the method for protecting privacy data of the vehicle is provided. The method includes steps of: obtaining current sensing data of the vehicle; determining whether a current location of the vehicle is within a predetermined privacy protection locating range; when the current location of the vehicle is not within the predetermined privacy protection locating range, determining the current sensing data to be non-private data and uploading the current sensing data to one or more remote devices of the vehicle; and when the current location of the vehicle is within the predetermined privacy protection locating range, determining the current sensing data to be private data and only saving the current sensing data to a local device of the vehicle.

In a second aspect, the vehicle is provided. The vehicle includes a memory, and a processor. The memory is configured to store a program instruction. The processor is configured to execute the program instruction to perform the method for protecting privacy data of the vehicle, the method for protecting privacy data of the vehicle includes steps of: obtaining the current sensing data of the vehicle; determining whether the current location of the vehicle is within the predetermined privacy protection locating range; when the current location of the vehicle is not within the predetermined privacy protection locating range, determining the current sensing data to be the non-private data and uploading the current sensing data to one or more remote devices of the vehicle; and when the current location of the vehicle is within the predetermined privacy protection locating range, determining the current sensing data to be the private data and only saving the current sensing data to the local device of the vehicle.

In a third aspect, the method for protecting privacy data of the vehicle is provided. The method includes steps of: obtaining the current sensing data of the vehicle; determining whether the current location of the vehicle is within the predetermined privacy protection locating range; when the current location of the vehicle is not within the predetermined privacy protection locating range, uploading the current sensing data to one or more remote devices of the vehicle; and when the current location of the vehicle is within the predetermined privacy protection locating range, only saving the current sensing data to the local device of the vehicle.

As described above, based on a user's setting of privacy protection locations, enables the data sensed by the vehicle within the predetermined privacy protection locating range to be stored only in the local device, enhances data protection of private locations, realizes the privacy storage of the current sensing data, and meets protection needs of the user of diversified privacy data in a user-friendly manner.

### BRIEF DESCRIPTION OF THE DRAWINGS

In order to illustrate the technical solution in the embodiments of the disclosure or the prior art more clearly, a brief description of drawings required in the embodiments or the prior art is given below. Obviously, the drawings described below are only some of the embodiments of the disclosure. For ordinary technicians in this field, other drawings can be obtained according to the structures shown in these drawings without any creative effort.

FIG. 1 illustrates a flow diagram of a method for protecting privacy data of a vehicle.

FIG. 2 illustrates a sub-flow diagram of the method for the protecting privacy data of the vehicle.

FIG. 3 illustrates a schematic diagram of a remote device of the vehicle.

FIG. 4 illustrates a flow diagram of user authentication for accessing a privacy storage area of the remote device.

FIG. 5 illustrates a flow diagram of determining statuses of sensors.

FIG. 6 illustrates a schematic diagram of a scenario applying the method for the protecting privacy data of the vehicle.

FIG. 7 illustrates a schematic diagram of the internal structure of the vehicle.

### DETAILED DESCRIPTION OF THE EMBODIMENTS

In order to make the purpose, technical solution and advantages of the disclosure more clearly, the disclosure is further described in detail in combination with the drawings and embodiments. It is understood that the specific embodiments described herein are used only to explain the disclosure and are not configured to define it. On the basis of the embodiments in the disclosure, all other embodiments obtained by ordinary technicians in this field without any creative effort are covered by the protection of the disclosure.

The terms “first”, “second”, “third”, “fourth”, if any, in the specification, claims and drawings of this application are configured to distinguish similar objects but need not be configured to describe any particular order or sequence of priorities. It should be understood that the data used here are interchangeable where appropriate, in other words, the embodiments described can be implemented in order other than what is illustrated or described here. In addition, the terms “include” and “have” and any variation of them, can encompass other things. For example, processes, methods, systems, products, or equipment that comprise a series of steps or units need not be limited to those clearly listed, but may include other steps or units that are not clearly listed or are inherent to these processes, methods, systems, products, or equipment.

It is to be noted that the references to “first”, “second”, etc. in the disclosure are for descriptive purpose only and neither be construed or implied the relative importance nor indicated as implying the number of technical features. Thus, feature defined as “first” or “second” can explicitly or implicitly include one or more such features. In addition, technical solutions between embodiments may be integrated, but only on the basis that they can be implemented by ordinary technicians in this field. When the combination of technical solutions is contradictory or impossible to be realized, such combination of technical solutions shall be deemed to be non-existent and not within the scope of protection required by the disclosure.

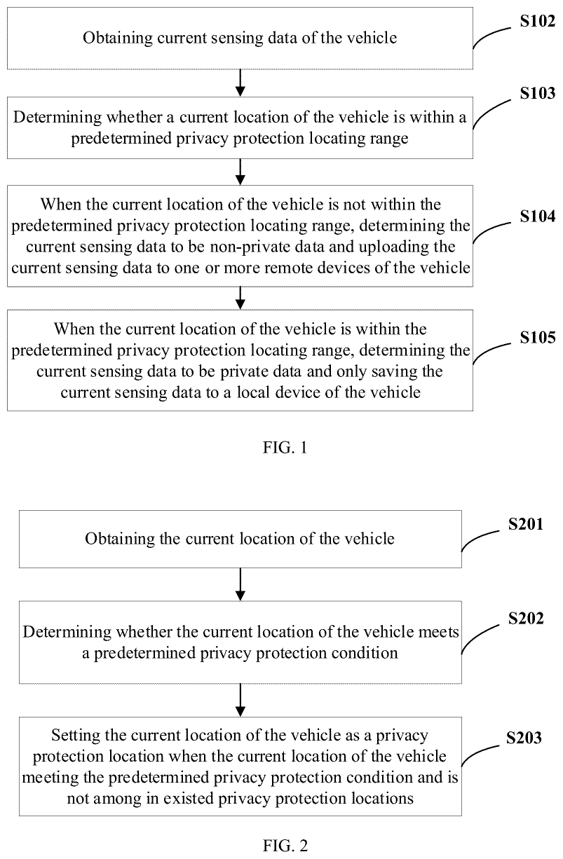

Referring to FIG. 1, a flow diagram of a method for protecting privacy data of a vehicle is illustrated in FIG. 1. The method for the protecting privacy data of the vehicle is a function of the vehicle to protect private data by executing a protection program for privacy data of the vehicle. The method for the protecting privacy data of the vehicle includes follows steps S102-S105.

At the step S102, current sensing data of the vehicle is obtained. Specifically, the current sensing data of the vehicle is obtained through sensors set up on the vehicle. In this embodiment, the sensors include, but are not limited to, Global locationing System (GPS), Inertial Navigation System (INS), Lidar, in-vehicle cameras, and the like. The current sensing data of the vehicle is obtained by fusing the data sensed by some or all of the sensors of the vehicle. In some other feasible embodiments, sensing may be performed by some of the sensors in the GPS, INS, Lidar, in-vehicle cameras. The current sensing data includes data sensed by a plurality of the sensors. The current sensing data of the vehicle includes video images and audio inside the vehicle, current video images around the vehicle, pictures of the front and back of the vehicle, and the like.

At the step S103, a current location of the vehicle is determined whether is within a predetermined privacy protection locating range. Wherein the predetermined privacy protection locating range is calculated based on privacy protection locations set by a user. It is understood that a privacy protection location is an address that can be found on a map. When the user uses the function of the vehicle to protect private data, the user may set the privacy protection location through user terminals connected to the vehicle, such as cell phones, tablets, or the like. Alternatively, the input of the privacy protection location is made directly through a center console of the vehicle. Specifically, the step S103 further includes steps of: planning a region centered on a privacy address with a radius of a predetermined distance when the privacy address inputted by the user is received; setting the region as the predetermined privacy protection locating range. Wherein, the setting of the predetermined distance is obtained by manual input by the user or default setting by systems of the vehicle.

At the step S104, the current sensing data is determined to be non-private data and uploaded to one or more remote devices of the vehicle when the current location of the vehicle is not within the predetermined privacy protection locating range. Wherein the remote device can be devices such as cloud servers, off-site database servers, other remote storage devices, etc.

At the step S105, the current sensing data is determined to be private data and only saved to a local device of the vehicle when the current location of the vehicle is within the predetermined privacy protection locating range. Specifically, the current sensing data of the vehicle is only stored in the local device of the vehicle, and cannot be uploaded to the remote device and cannot be exported to an external storage device. In some feasible embodiments, the external storage device may be a USB flash drive, a removable hard disk, a Smart Media Card (SMC), etc. In other words, the private data can only be read in the vehicle and cannot be copied or uploaded, thus ensuring that the private data will not be leaked. Users do not have to worry about the leakage of the private data when using applications with monitoring function in the vehicle, so they can use it with more peace of mind.

In this embodiment, the method further includes steps of: determining whether the current location of the vehicle belongs to a candidate privacy protection location when the current location of the vehicle being not within the predetermined privacy protection locating range; when the current location of the vehicle belongs to the candidate privacy protection location, outputting setting information on a user terminal to prompt the user to set the predetermined privacy protection locating range base on the current location. Wherein the candidate privacy protection location may be a historical privacy protection location set by other users or the user. Wherein the candidate privacy protection location is also a privacy protection location that was not set as the privacy protection location by the user but was set as the privacy protection location by other users, or is obtained based on the user's habits of the privacy protection location set by the user. For example, if the location set as a privacy protection location by the user is hotels, office areas, etc., the corresponding revelation can be outputted for setting by the user when the vehicle is close to these locations, thus avoiding the user from inadvertently. In this way, the prompting method of the candidate privacy protection location is increased, which is more convenient for the user to carry out the privacy protection location, and makes the privacy protection location of the user more comprehensive.

In these above embodiments, by combining the vehicle's own localization with the predetermined privacy protection locating range, the protection of the privacy data in a private location of the vehicle is realized in an efficient and timely manner.

Referring to FIG. 2, a sub-flow diagram of the method for protecting privacy data of the vehicle is illustrated in FIG. 2. Before the step S103, the method further includes follows steps S201-S203.

At the step S201, the current location of the vehicle is obtained. The current location of the vehicle can be obtained by the GPS of the vehicle.

At the step S202, the current location of the vehicle is determined whether meets a predetermined privacy protection condition.

In this embodiment, the predetermined privacy protection condition is set according to types of place. The types of place include hotels, office buildings, shopping malls, neighborhood parking lots, and so on. For example, the predetermined privacy protection condition is set to a hotel. When the current location of the vehicle is the hotel, the current location of the vehicle is considered to meet the predetermined privacy protection condition. Another example is that the predetermined privacy protection condition is set to community parking lots, and if the current location of the vehicle is in a community parking lot, the current location of the vehicle is considered to meet the predetermined privacy protection condition, and so on. Therefore, we will not list other cases that meet the predetermined privacy protection conditions here.

At the step S203, the current location of the vehicle is set as the privacy protection location when the current location of the vehicle meeting the predetermined privacy protection condition and is not among in existed privacy protection locations.

In this embodiment, instead of entering each privacy protection location, the user can also set the privacy protection location automatically by setting the conditions corresponding to the privacy protection location, making it easier for users to set up. For example, navigation information for the user is obtained firstly. The navigation information includes a starting location, an end location, and locations to be passed from the starting location to the end location. The starting location, the end location, and the locations to be passed are extracted from the starting location to the end location, and setting information of the privacy protection location for the user is displayed to set the privacy protection location according to the starting location, the end location, and the locations to be passed from the starting location to the end location. Exemplarily, the vehicle is located in a shopping mall, and the end location is a school. At this time, the user is shown the privacy protection locations of other users such as hotels, parking lots, etc., through which the navigation route passes, or historical privacy protection locations. The user can select one or more locations and set them as privacy protection locations.

In this embodiment, a user-friendly graphical user interface is provided. The graphical user interface displays to the user a setting interface for attributes of the privacy protection location. The attributes include an effective frequency of the privacy protection location, and an update of the privacy protection location. When the user makes a setting of the privacy protection location, the user is provided with an option to set the effective frequency. For example, the privacy protection location is effective once, permanently effective, and other setting options. When the user makes the setting of the effective frequency, a number of effective times is counted, and when the effective frequency is reached, all settings for the privacy protection location are canceled and saved as the historical privacy protection location record for candidates. The setting for updating the privacy protection location includes a setting switch that prompts the user to update the privacy protection location within a certain time period. If the user does not check the setting switch for the privacy protection location, the user is never prompted to update the privacy protection location. If the user checks said setting switch, providing the user with setting options for that time period. For example, the user is prompted to update the privacy location on a weekly basis, the user is prompted to update the privacy location on a monthly basis, etc. The personalized and customized settings of the privacy protection location attributes satisfy the diversified needs of the user and make the privacy data protection more user-friendly.

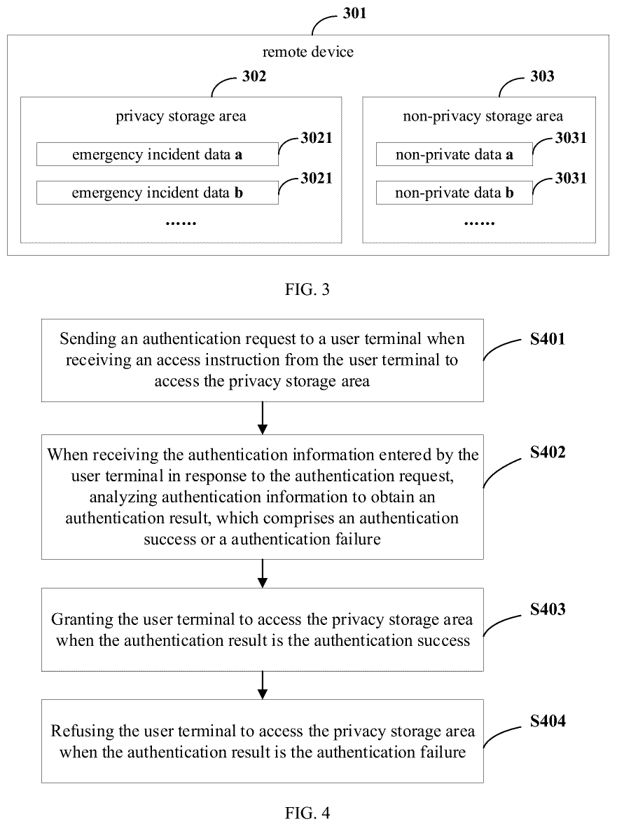

Referred to FIG. 3, a schematic diagram of a remote device of the vehicle is illustrated in FIG. 3. The remote device 301 includes a privacy storage area 302 and a non-privacy storage area 303. The privacy storage area 302 stores a plurality of emergency incident data 3021. The non-privacy storage area 303 stores a plurality of non-private data 3031. The privacy storage area 302 is accessible to a first group of users and not accessible to a second group of users. The non-privacy storage area 303 is accessible to the first group of users and the second group of users. Specifically, the first group of users includes, but is not limited to, users such as administrators, drivers, and the like. The first group of users is capable of verifying user authentication through systems of the vehicle. The second group of users are other users or visitors. The first group of users has an authority to authorize the second group of users to access the privacy storage area 302.

In some feasible embodiments, the method further includes steps of: analyzing whether the privacy data contains the emergency incident data 3021; sending the emergency incident data 3021 to the remote device 301 when the privacy data containing the emergency incident data 3021, and saving the emergency incident data 3021 in the privacy storage area 302. Specifically, the emergency incident data 3021 includes manually marking road sections or locations to generate an unexpected event, or obtaining an emergency incident based on the sensors in the vehicle and the location sensing system automatically determining whether the emergency incident has occurred. When the emergency incident occurs, the emergency incident data 3021 is uploaded to the privacy storage area 302 of the remote device 301. Besides, when the emergency incident occurs, the emergency incident data 3021 is uploaded to an emergency disposal platform in a certain degree. The emergency disposal platform includes, but is not limited to, a traffic police department, an insurance company, and the like, and is not limited herein.

Referred to FIG. 4, a flow diagram of user authentication for accessing a privacy storage area of the remote device is illustrated in FIG. 4. The method further includes follows steps S401-S404.

At the step S401, an authentication request is sent to the user terminal when receiving an access instruction from the user terminal to access the privacy storage area 302. In this embodiment, the access instruction may also be sent to terminals of the first group of users to allow the user to access the privacy storage area 302 after obtaining confirmation of authorization from the first group of users.

At the step S402, when receiving the authentication information entered by the user terminal in response to the authentication request, authentication information is analyzed to obtain an authentication result, which includes an authentication success or a authentication failure.

At the step S403, the user terminal is granted to access the privacy storage area when the authentication result is the authentication success.

At the step S404, the user terminal is refused to access the privacy storage area when the authentication result is the authentication failure.

In some feasible embodiments, the method further sets levels of a privacy protection range. The levels of a privacy protection range includes a first-level of a privacy protection range and a second-level of a privacy protection range.

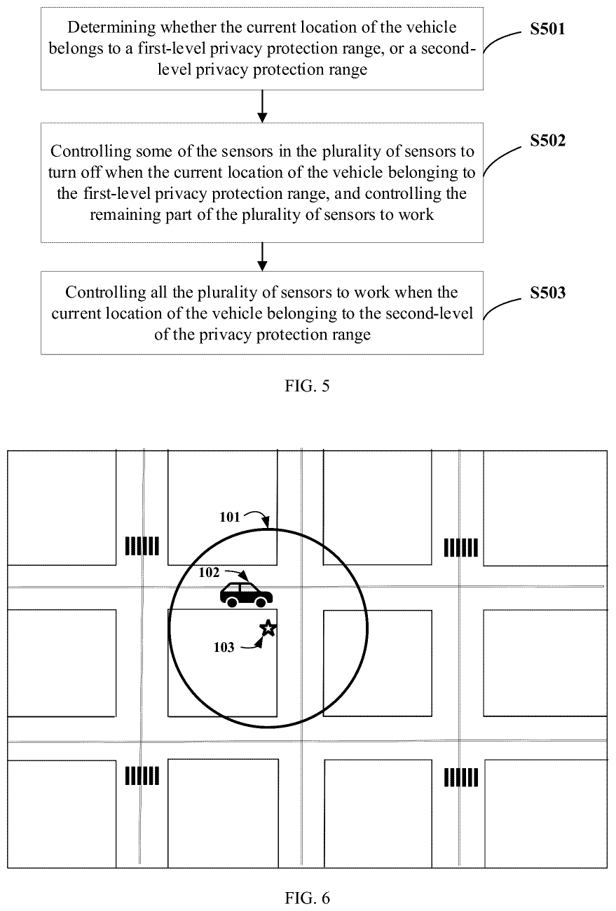

Referred to FIG. 5, a flow diagram of determining statuses of sensors is illustrated in FIG. 5. The method further includes follows steps S501-S503.

At the step S501, the current location of the vehicle determined whether belongs to a first-level privacy protection range, or a second-level privacy protection range. Specifically, the first-level privacy protection range is a privacy protection range that meets the predetermined privacy protection condition. The second-level of the privacy protection range is a privacy protection range that does not meet the predetermined privacy protection condition.

At the step S502, some of the sensors in the plurality of sensors are controlled to turn off when the current location of the vehicle belonging to the first-level privacy protection range, and the remaining part of the plurality of sensors are controlled to work. Some of the sensors controlled to turn off can be cameras, microphones, accelerometers, gyroscopes, etc., not listed here.

At the step S503, all the plurality of sensors are controlled to work when the current location of the vehicle belonging to the second-level of the privacy protection range.

Referred to FIG. 6, a schematic diagram of a scenario applying the method for the protecting privacy data of the vehicle is illustrated in FIG. 6. The application scenario includes the vehicle 102, the predetermined privacy protection locating range 101, and the privacy address 103. A region centered on the privacy address 103 with the radius of the predetermined distance is planned when receiving the privacy address 103 selected by the user, and the region is set as the predetermined privacy protection locating range 101. When the vehicle 102 is within the predetermined privacy protection locating range 101, the current sensing data of the vehicle 102 is identified as privacy data and stored in the local device of the vehicle 102. If the emergency incident is generated by the vehicle 102 within the predetermined privacy protection locating range 101, the emergency incident data 3021 is uploaded to the privacy storage area 302 of the remote device. Besides, access to the privacy storage area 302 is subject to user authentication to ensure data privacy security.

In some feasible embodiments, the method further includes steps of: obtaining the current sensing data of the vehicle; determining whether the current location of the vehicle is within the predetermined privacy protection locating range; when the current location of the vehicle is not within the predetermined privacy protection locating range, uploading the current sensing data to one or more remote devices of the vehicle; when the current location of the vehicle is within the predetermined privacy protection locating range, only saving the current sensing data to the local device of the vehicle.

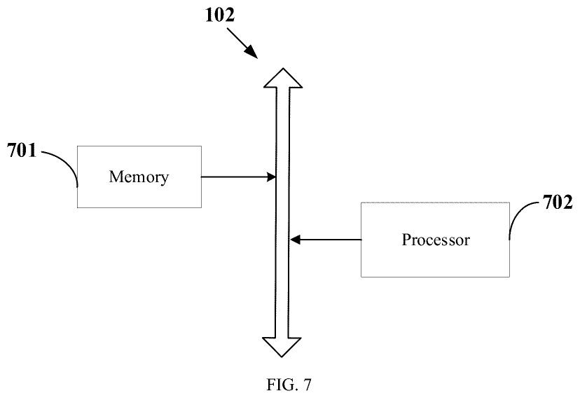

Referred to FIG. 7, a schematic diagram of the internal structure of the vehicle is illustrated in FIG. 7. The vehicle 102 includes a memory 702, and a processor 701. The memory 702 is configured to store a program instruction. The processor 701 is configured to execute the program instruction to perform the method for protecting privacy data of the vehicle. Wherein the processor 701 may in some embodiments be a central processing unit (CPU), a controller, a micro-controller, a microprocessor, or other data processing chip for running the program instruction stored in the memory 702 or for processing data. Specifically, the processor 701 executes the program instruction of the method for protecting privacy data of the vehicle.

The memory 702 includes at least one type of the computer-readable storage medias. The memory 702 includes a flash memory, a hard disk, a multimedia card, a card type storage (for example, an SD or a DX storage, etc.), a magnetic storage, a disks, an optical disks, etc. The memory 702 may in some embodiments be an internal storage unit of a computer device, such as the hard disk of the computer device. The memory 702 may also be an external storage device of a computer device in other embodiments, such as a plug-in hard disk, a smart media card (SMC), a secure digital card (SD), a flash card, etc., equipped on a computer device. Furthermore, the memory 702 may include both the internal storage unit of the computer device and the external storage device. The memory 702 can not only be used to store the application software and all kinds of data installed in the computer device, such as the program instruction of the method for protecting privacy data of the vehicle, but also can be used to temporarily store the data that has been output or will be output.

In the above embodiment, based on the user's setting of privacy protection locations, enables the data sensed by the vehicle within the predetermined privacy protection locating range to be stored only in the local device, enhances data protection of private locations, realizes the privacy storage of the current sensing data, and meets protection needs of the user of diversified privacy data in a user-friendly manner.

It should be noted that the embodiments number of this disclosure above is for description only and do not represent the advantages or disadvantages of embodiments. And in this disclosure, the term “including”, “include” or any other variants is intended to cover a non-exclusive contain. So that the process, the devices, the items, or the methods includes a series of elements not only include those elements, but also include other elements not clearly listed, or also include the inherent elements of this process, devices, items, or methods. In the absence of further limitations, the elements limited by the sentence “including a . . . ” do not preclude the existence of other similar elements in the process, devices, items, or methods that include the elements.

The above disclosed preferred embodiments of the invention are intended only to assist in the elaboration of the invention. The preferred embodiment does not elaborate on all the details and does not limit the invention to a specific embodiment. Obviously, according to the contents of this instruction manual, a lot of amendments and changes can be made. These embodiments are selected and described in detail in this specification for the purpose of better explaining the principle and practical application of the invention, so that the technical personnel in the technical field can better understand and utilize the invention. The invention is limited only by the claims and their full scope and equivalents.

The above are only the preferred embodiments of this disclosure and do not therefore limit the patent scope of this disclosure. And equivalent structure or equivalent process transformation made by the specification and the drawings of this disclosure, either directly or indirectly applied in other related technical fields, shall be similarly included in the patent protection scope of this disclosure.

What is claimed is:

1. A method for protecting privacy data of a vehicle, comprising:
obtaining current sensing data of the vehicle;
determining whether a current location of the vehicle is within a predetermined privacy protection locating range;
when the current location of the vehicle is not within the predetermined privacy protection locating range, determining the current sensing data to be non-private data and uploading the current sensing data to one or more remote devices of the vehicle; and
when the current location of the vehicle is within the predetermined privacy protection locating range, determining the current sensing data to be private data and only saving the current sensing data to a local device of the vehicle.

2. The method according to claim 1, further comprising:
planning a region centered on a privacy address with a radius of a predetermined distance when the privacy address inputted by a user is received;
setting the region as the predetermined privacy protection locating range.

3. The method according to claim 1, wherein the remote device comprises a privacy storage area and a non-privacy storage area; the privacy storage area is accessible to a first group of users and not accessible to a second group of users; the non-privacy storage area is accessible to the first group of users and the second group of users; the method further comprising:
analyzing whether the privacy data contains emergency incident data;
sending the emergency incident data to the remote device when the privacy data containing the emergency incident data, and saving the emergency incident data in the privacy storage area.

4. The method according to claim 1, further comprising:
sending an authentication request to a user terminal when receiving an access instruction from the user terminal to access the privacy storage area;
when receiving the authentication information entered by the user terminal in response to the authentication request, analyzing authentication information to obtain an authentication result, which comprises an authentication success or a authentication failure;
granting the user terminal to access the privacy storage area when the authentication result is the authentication success;
refusing the user terminal to access the privacy storage area when the authentication result is the authentication failure.

5. The method according to claim 1, further comprising:
determining whether the current location of the vehicle belongs to a candidate privacy protection location when the current location of the vehicle being not within the predetermined privacy protection locating range;
when the current location of the vehicle belongs to the candidate privacy protection location, outputting setting information on a user terminal to prompt a user to set the predetermined privacy protection locating range base on the current location.

6. The method according to claim 1, further comprising:
obtaining the current location of the vehicle;
determining whether the current location of the vehicle meets a predetermined privacy protection condition;
setting the current location of the vehicle as a privacy protection location when the current location of the vehicle meeting the predetermined privacy protection condition and is not among in existed privacy protection locations.

7. The method according to claim 6, wherein the predetermined privacy protection condition is set according to types of place.

8. The method according to claim 5, further comprising:
obtaining navigation information containing a starting location, an end location, and a rout from the starting location to the end location;
extracting the starting location, the end location, and the locations to be passed from the starting location to the end location, and displaying setting information of the privacy protection location for the user to set the privacy protection location according to the starting location, the end location, and the locations to be passed from the starting location to the end location.

9. The method according to claim 1, wherein the current sensing data is acquired by a plurality of sensors; the method further comprising:
determining whether the current location of the vehicle belongs to a first-level privacy protection range, or a second-level privacy protection range;
controlling some of the sensors in the plurality of sensors to turn off when the current location of the vehicle belonging to the first-level privacy protection range, and controlling the remaining part of the plurality of sensors to work; and
controlling all the plurality of sensors to work when the current location of the vehicle belonging to the second-level of the privacy protection range.

10. A vehicle, comprising:
a memory, configured to store a program instruction; and
a processor, configured to execute the program instruction to perform a method for protecting privacy data of a vehicle, the method for protecting privacy data of the vehicle comprising:
obtaining current sensing data of the vehicle;
determining whether a current location of the vehicle is within a predetermined privacy protection locating range;
when the current location of the vehicle is not within the predetermined privacy protection locating range, determining the current sensing data to be non-private data and uploading the current sensing data to one or more remote devices of the vehicle; and
when the current location of the vehicle is within the predetermined privacy protection locating range, determining the current sensing data to be private data and only saving the current sensing data to a local device of the vehicle.

11. The vehicle according to claim 10, wherein the method further comprising:
planning a region centered on a privacy address with a radius of a predetermined distance when the privacy address inputted by a user is received;
setting the region as the predetermined privacy protection locating range.

12. The vehicle according to claim 10, wherein the remote device comprises a privacy storage area and a non-privacy storage area; the privacy storage area is accessible to a first group of users and not accessible to a second group of users; the non-privacy storage area is accessible to the first group of users and the second group of users; the method further comprising:
analyzing whether the privacy data contains emergency incident data;
sending the emergency incident data to the remote device when the privacy data containing the emergency incident data, and saving the emergency incident data in the privacy storage area.

13. The vehicle according to claim 10, further comprising:
sending an authentication request to a user terminal when receiving an access instruction from the user terminal to access the privacy storage area;
when receiving the authentication information entered by the user terminal in response to the authentication request, analyzing authentication information to obtain an authentication result, which comprises an authentication success or a authentication failure;
granting the user terminal to access the privacy storage area when the authentication result is the authentication success;
refusing the user terminal to access the privacy storage area when the authentication result is the authentication failure.

14. The vehicle according to claim 10, further comprising:
determining whether the current location of the vehicle belongs to a candidate privacy protection location when the current location of the vehicle being not within the predetermined privacy protection locating range;
when the current location of the vehicle belongs to the candidate privacy protection location, outputting setting information on a user terminal to prompt a user to set the predetermined privacy protection locating range base on the current location.

15. The vehicle according to claim 10, further comprising:
obtaining the current location of the vehicle;
determining whether the current location of the vehicle meets a predetermined privacy protection condition;
setting the current location of the vehicle as a privacy protection location when the current location of the vehicle meeting the predetermined privacy protection condition and is not among in existed privacy protection locations.

16. The vehicle according to claim 15, wherein the predetermined privacy protection condition is set according to types of place.

17. The vehicle according to claim 14, further comprising:
obtaining navigation information containing an starting location, an end location, and a rout from the starting location to the end location;
extracting the starting location, the end location, and the locations to be passed from the starting location to the end location, and displaying setting information of the privacy protection location for the user to set the privacy protection location according to the starting location, the end location, and the locations to be passed from the starting location to the end location.

18. The vehicle according to claim 10, wherein the current sensing data is acquired by a plurality of sensors; the method further comprising:
determining whether the current location of the vehicle belongs to a first-level privacy protection range, or a second-level privacy protection range;
controlling some of the sensors in the plurality of sensors to turn off when the current location of the vehicle belonging to the first-level privacy protection range, and controlling the remaining part of the plurality of sensors to work; and
controlling all the plurality of sensors to work when the current location of the vehicle belonging to the second-level of the privacy protection range.

19. A method for protecting privacy data of a vehicle, comprising:
obtaining current sensing data of the vehicle;
determining whether a current location of the vehicle is within a predetermined privacy protection locating range;
when the current location of the vehicle is not within the predetermined privacy protection locating range, uploading the current sensing data to one or more remote devices of the vehicle; and
when the current location of the vehicle is within the predetermined privacy protection locating range, only saving the current sensing data to a local device of the vehicle.

20. The method according to claim 19, further comprising:
planning a region centered on a privacy address with a radius of a predetermined distance when a privacy address inputted by a user is received; and
setting the region as the predetermined privacy protection locating range.
